(19) United States
(12) Patent Application Publication
(10) Pub. No.: US 2001/0046113 A1
(43) Pub. Date: Nov. 29, 2001

(54) Alloy Compositions for use as electrode materials and for hydrogen production

(76) Inventor: David G. Schmidt, Dahlonega, GA (US)

Correspondence Address: John K. McDonald, Ph.D., KILPATRICK STOCKTON LLP, 2400 Monarch Tower, 3424 Peachtree Road, N.E., Atlanta, GA, 30326, US

(21) Appl. No.: 09/775,550

(22) Filed: Feb. 5, 2001

Related U.S. Application Data
(60) Provisional application No. 60/181,263, filed on Feb. 9, 2000.

(51) Int. Cl. H01G 9/04

(52) U.S. Cl. 361/508

(57) ABSTRACT

This invention provides novel metal alloys, methods for making these alloys, and methods of using these alloys in numerous applications. The alloys of the present invention comprise the following components: (A) one or more of the transition metal elements; at least one of either (B) aluminum or (C) one or more of the group 1A alkali metal elements; and (D) one or more elements and/or compounds having high mobility values for electrons. Thus, components A, D, and at least one of components B or C comprise the present invention. These alloys are useful as electrode materials in devices such as batteries, capacitors, fuel cells and similar devices, and useful in the direct production of hydrogen gas.

### PRIOR RELATED U.S. APPLICATION DATA

This application claims priority to U.S. provisional application Serial No. 60/181,263, filed Feb. 9, 2000.

### TECHNICAL FIELD OF THE INVENTION

The present invention provides new alloy compositions, methods for making these alloys, and methods of using these alloys as electrode materials in a range of applications, including batteries, capacitors, fuel cells and similar devices. The novel alloys of the present invention may also be used as a source of hydrogen gas.

### BACKGROUND OF THE INVENTION

Alloys are used in enhancing the performance of batteries, capacitors, fuel cells, and similar devices. One principal application of alloys is in electrode materials, therefore advancements in energy production have paralleled developments in alloy performance. Electrodes may function in many ways, and numerous electrode materials are typically available for specific applications. For example, primary batteries often use electrodes comprising zinc as a principal component. In this case, the zinc electrode serves as a source of electrons, but once all the zinc has been oxidized, the primary battery is exhausted. Therefore, any primary battery system stops working and must be discarded after one of its chemicals has been depleted. The total amount of energy produced by this type of primary battery system depends upon how much active material is contained within the battery.

Capacitors are devices that store electrical energy and then rapidly discharge that energy when required. Electrode materials play a key role in capacitor performance. For example, the aluminum electrolytic capacitor, as disclosed in U.S. Pat. No. 5,448,448, represents a typical electrolytic capacitor. Great emphasis is placed on the voltage rating of the capacitor as well as its ability to store electrons (rated in Farads). In certain applications, there would be great advantage for the capacitor to be able to both rapidly generate and also discharge energy. The majority of capacitors found in the prior art do not possess both of these attributes.

Another type of electrode is used in fuel cells. A fuel cell operates as a galvanic cell wherein one of the reactants is a fuel, such as hydrogen or methane. One such fuel cell system is disclosed in U.S. Pat. No. 5,962,155. Fuel cells may operate using platinum electrodes or porous carbon electrodes containing metal catalysts. In contrast to the electrodes of a primary battery, fuel cell electrodes are not the source of electrons but serve primarily to interact with the fuel and to shuttle electrons through the cell. A fuel cell reactant is not contained within the cell, but must be continuously supplied from an external source. Although fuel cells show great promise as a replacement to some portable energy sources, the cost and the problems associated with the storage and delivery of fuels such as hydrogen have prohibited their widespread use.

An associated problem in energy technology, especially related to fuel cell operation, is that of generating and storing hydrogen gas. The use of hydrogen gas as a fuel is environmentally advantageous, because hydrogen burns in the presence of oxygen to yield water as a by-product. The dominant industrial process for producing hydrogen is the catalytic steam-hydrocarbon reforming process using natural gas (largely methane) or oil-refinery feedstocks at high temperatures (e.g. 900° C.). Hydrogen gas is stored in compressed gas cylinders for transport and use elsewhere. On a smaller scale, hydrogen gas may be produced by the well-known electrolysis method, but energy must be supplied from other sources for this process. The reaction of acid with many metals produces hydrogen gas, but this method is more useful in small scale applications and is not economically feasible. Another means for generating hydrogen gas is to store the hydrogen in the form of a metal hydride. While this technology stores hydrogen more safely than in compressed gas tanks, after the hydrogen is consumed, the metal hydride must again be recharged with hydrogen gas.

What is needed are new ways to generate hydrogen. What is also needed is a way to store and utilize hydrogen safely for energy production in remote locations where it may be used for combustion, fuel cell operation, or other energy applications. What is also needed are new and better alloy compositions that exceed the performance capabilities of those currently used in devices such as batteries, capacitors, and fuel cells. What is also needed is a hybrid electrode that could serve more than one energy production function, such as a hybrid fuel cell using electrodes for both hydrogen production and electron transfer functions.

### SUMMARY OF THE INVENTION

The present invention provides alloys, methods for making these alloys, and methods of using these alloys in a wide variety of applications. All of the alloys of the present invention may be used for electrode materials in batteries, capacitors, fuel cells, and the like, as well as for the production of hydrogen gas.

The new alloys of the present invention comprise: (A) one or more of the transition metal elements; at least one of either (B) aluminum or (C) one or more of the group 1A alkali metal elements; and (D) one or more elements and/or compounds having high mobility values for electrons. Thus, components A, D, and at least one of components B and C are necessary components of the present invention.

There are generally three types of alloys of the present invention, and each type of alloy may be used for any of the applications described herein.

One type of alloy of the present invention comprises components A, B, C, and D recited immediately above. Therefore, this type of alloy comprises: (A) one or more of the transition metal elements; (B) aluminum; (C) one or more of the group 1A alkali metal elements; and (D) one or more elements and/or compounds having high mobility values for electrons.

Another type of alloy of the present invention comprises components A, B, and D recited above. Therefore, this type of alloy comprises: (A) one or more of the transition metal elements; (B) aluminum; (C) no alkali metal elements; and (D) one or more elements and/or compounds having high mobility values for electrons.

Yet another type of alloy of the present invention comprises components A, C, and D recited above. Therefore, this type of alloy comprises: (A) one or more of the transition metal elements; (B) no aluminum; (C) one or more of the group 1A alkali metal elements; and (D) one or more elements and/or compounds having high mobility values for electrons.

The alloys of the present invention have a range of potential uses, including, but not limited to, use as electrode materials in a number of energy production and storage devices, and as materials for the production of hydrogen. Thus, the alloys are useful as components of batteries, capacitors, fuel cells, hybrid battery/fuel cell designs, and the like. When used as an electrode material in primary batteries, the alloys of the present invention address the limitations of prior art technologies by providing a battery with improved energy density compared to conventional primary battery systems.

The alloys of the present invention are useful as an electrode material in a capacitor device. The present invention overcomes the limitations of prior art technologies by allowing the capacitor to both store and generate electrical energy, unlike conventional capacitors which can only store energy. This improvement provides a capacitor with a greater energy density and more potential applications than currently available with conventional capacitor systems.

The alloys of the present invention are useful as electrode materials in a hybrid fuel cell device. The present invention overcomes the limitations of prior art technologies by allowing the alloy material to serve as both electrode and fuel source for the fuel cell device. This feature circumvents the need to provide hydrogen fuel separately, and has the advantage of using the fuel cell electrolyte as an electron transport medium. Such a fuel cell has a greater energy density and more potential applications than available with conventional fuel cell systems. Moreover, the alloys of the present invention are considerably less expensive than the platinum or platinum alloy electrodes of conventional hydrogen fuel cells.

The alloys of the present invention are useful for the production of hydrogen. In alloys that contain group 1A alkali metals, it is only necessary to add water to activate the sample to produce hydrogen. In alloys of the present invention that do not contain alkali metals, aqueous hydroxide ion is added to activate the sample to produce hydrogen.

In most reactions in which an alkali metal contacts water, hydrogen and heat energy are liberated very rapidly, sometimes explosively, because hydrogen formed may ignite as it is generated. In contrast, the alloy compositions of the present invention release hydrogen and energy over a period of a few hours to a few weeks when contacted with water. Thus, these alloy compositions overcome prior art limitations of producing hydrogen from alkali metal and water, by sustaining and extending the release of hydrogen gas in a more controlled fashion. This feature also provides several advantages over other prior art methods for producing hydrogen. First, electricity is not needed to generate the hydrogen as in known electrolysis systems. Second, hydrogen gas is generated on demand when needed and not stored under high pressure in compressed gas tanks. Third, the alloys of the present invention liberate hydrogen gas more efficiently than conventional metal hydride storage systems. These alloy compositions may be used in applications where it is desirable for the alloy to react only with water, or with water containing other materials such as salts or contaminants.

Once generated, hydrogen gas may be used in various applications including, but not limited to, internal combustion engines, heating, ion propulsion, magnetohydrodynamics (MHD), fuel cells, welding, hydrogenation of oils, hydrogenation of petroleum and petrochemical fuels, hydrogenation of polymer related materials, reduction of organic compounds, reduction of inorganic and organometallic compounds, hydrogenation of volatile materials in vapor deposition processes, conventional jet propulsion, rocket fuel, and other applications.

In addition to the utility of the alloys in a fuel cell design described above, wherein the alloys serve as both an electrode material and fuel source, the alloys of the present invention also serve as a fuel source for a conventional fuel cell. Because hydrogen is generated on demand, an advantage is gained over fuel cells that store hydrogen in compressed gas tanks or other means.

The transition metal elements used in the present invention comprise the metals in groups 1B, 2B, 3B, 4B, 5B, 6B, 7B, and 8B, of the periodic table. The group 1A alkali metals of the periodic table comprise Li, Na, K, Rb, Cs, and Fr. Elements and/or compounds having high mobility values for electrons are semiconductor materials that are characterized by an electron mobility value from about 100 cm²/V·s to about 100,000 cm²/V·s.

While not wanting to be bound by the following statement, it is believed that because these components are processed into the alloys of the present invention by melting, intermetallic compounds may form as a result of reactions between at least two of these components based upon an examination of the binary phase diagrams. For example, in one embodiment, the alloy comprises nickel, aluminum, lithium, and germanium, and possible intermetallic compounds include, but are not limited to, compounds of aluminum-germanium, aluminum-lithium, aluminum-nickel, germanium-lithium, germanium-nickel, lithium-nickel, and mixed compounds including three and four-element compounds.

An examination of the metallurgical phase diagrams for selected elements or compounds, recited as A, B, C or D above, suggests that large macrosegregation domains will result from the limited solubilities of these components in their desired percentages. Therefore, the present invention also provides a method of manufacturing the alloys that reduces macrosegregation and improves homogeneity in an otherwise nonhomogeneous sample.

The alloys of the present invention are prepared by combining and melting the components of the alloy in a standard arc melting furnace, induction furnace, vapor deposition chamber, or sintering furnace in ways known to one of ordinary skill in the art. In some embodiments of this invention, it is desirable to form intermediate or pre-melt alloys comprising a subset of the alloy components, and subsequently use the intermediate alloy(s) in a melting step along with the remaining alloy components. Typically, sufficient physical agitation accompanies the arc melting process to afford the preferred high sample homogeneity. While some physical agitation accompanies the induction melting process, it may or may not be necessary to apply additional physical agitation and/or sonication treatments to the melted sample to achieve the preferred high sample homogeneity. These treatments are made during the cooling step while the pre-melt alloy or final melt alloy sample is still in the liquid state.

The novel alloys of the present invention comprise: (A) one or more of the transition metal elements; at least one of either (B) aluminum or (C) one or more of the group 1A alkali metal elements; and (D) one or more elements and/or compounds having high mobility values for electrons.

In one type of alloy of the present invention, the alloy comprises (A) one or more of the transition metal elements; (B) aluminum; (C) one or more of the group 1A alkali metal elements; and (D) one or more elements and/or compounds having high mobility values for electrons. One preferred embodiment of this type of alloy contains nickel, aluminum, lithium, and germanium.

In another type of alloy of the present invention, the alloy comprises: (A) one or more of the transition metal elements; (B) aluminum; (C) no alkali metal elements; and (D) one or more elements and/or compounds having high mobility values for electrons. One preferred embodiment of this type of alloy contains nickel, aluminum, and germanium.

In yet another type of alloy of the present invention, the alloy comprises: (A) one or more of the transition metal elements; (B) no aluminum; (C) one or more of the group 1A alkali metal elements; and (D) one or more elements and/or compounds having high mobility values for electrons. One preferred embodiment of this type of alloy contains nickel, lithium, and indium antimonide.

Accordingly, it is an object of the present invention to provide novel alloys.

It is an object of the present invention to provide alloys comprising: (A) one or more of the transition metal elements; at least one of either (B) aluminum or (C) one or more of the group 1A alkali metal elements; and (D) one or more elements and/or compounds having high mobility values for electrons.

It is an object of the present invention to provide alloys comprising: (A) one or more of the transition metal elements; (B) aluminum; (C) one or more of the group 1A alkali metal elements; and (D) one or more elements and/or compounds having high mobility values for electrons.

It is another object of the present invention to provide alloys comprising: (A) one or more of the transition metal elements; (B) aluminum; (C) no alkali metal elements; and (D) one or more elements and/or compounds having high mobility values for electrons.

It is yet another object of the present invention to provide alloys comprising: (A) one or more of the transition metal elements; (B) no aluminum; (C) one or more of the group 1A alkali metal elements; and (D) one or more elements and/or compounds having high mobility values for electrons.

It is another object of the present invention to provide methods of making the novel alloys of the present invention.

Yet a further object of the present invention is to provide suitable methods of manufacturing the alloys of the present invention, including but not limited to, arc melting, induction melting, physical vapor deposition, chemical vapor deposition, and sintering.

A further object of the present invention is to provide alloys useful as electrode materials.

Another object of the present invention is to provide alloys useful as electrode materials in devices such as batteries, capacitors, fuel cells and similar devices.

A further object of the present invention is to provide alloys that generate hydrogen gas.

Yet another object of the present invention is to provide alloys that produce hydrogen gas upon contact with water or with aqueous hydroxide ion, thereby providing alloys that may be used in numerous applications requiring hydrogen gas.

Yet another object of the present invention is to provide alloys that produce hydrogen gas upon contact with water, thereby providing alloys that may be used in numerous applications requiring hydrogen gas. These applications include, but are not limited to, in internal combustion engines, heating, ion propulsion, magnetohydrodynamics (MHD), fuel cells, welding, hydrogenation of oils, hydrogenation of petroleum and petrochemical fuels, hydrogenation of polymer related materials, reduction of organic compounds, reduction of inorganic and organometallic compounds, hydrogenation of volatile materials in vapor deposition processes, conventional jet propulsion, rocket fuel, and other applications.

Another object of the present invention is to provide alloy compositions useful in a hybrid battery system.

Another object of the present invention is to provide alloy compositions useful as a fuel source in a fuel cell.

Yet another object of the present invention is to provide alloy compositions useful in a hybrid battery system where the alloys serve as both electrode and fuel source for the fuel cell device.

It is a further object of the present invention to provide a method of producing hydrogen that does not require the use of electricity.

Yet another object of the present invention is to provide a method of hydrogen production in which hydrogen gas is generated on demand when needed and is not stored under high pressure in compressed gas tanks.

A further object of the present invention is to provide alloys that liberate hydrogen gas more efficiently than in conventional metal hydride storage systems.

These and other objects, features and advantages of the present invention will become apparent after a review of the following detailed description of some of the disclosed embodiments.

### BRIEF DESCRIPTION OF THE DRAWING

FIG. 1 illustrates the hydrogen gas production from one embodiment of the present invention, namely the sodium-containing alloy described in Example 6.

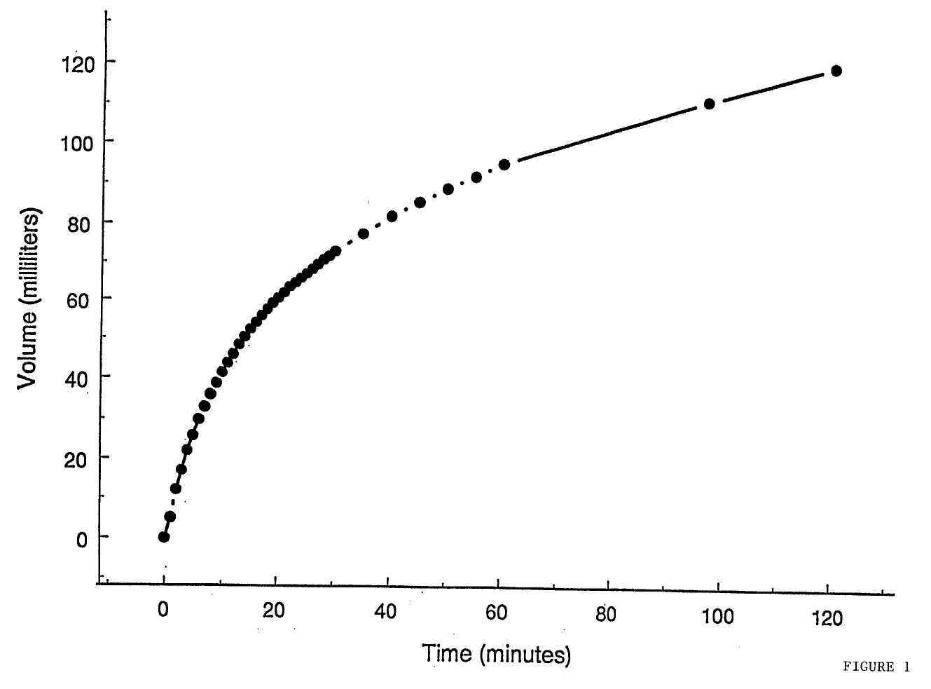

### DETAILED DESCRIPTION OF THE PRESENT INVENTION

The present invention provides novel alloy compositions, methods of making the alloys and methods of using the alloys in a wide range of applications. The new alloys of the present invention comprise: (A) one or more of the transition metal elements; at least one of either (B) aluminum or (C) one or more of the group 1A alkali metal elements; and (D) one or more elements and/or compounds having high mobility values for electrons. Thus, components A, D, and at least one of components B or C are necessary ingredients of the present invention. Numerous applications for these alloys are disclosed, such as uses in electrode materials in batteries, capacitors, fuel cells, and the like, and any of the alloys of the present invention may be used in any of these applications.

In one type of alloy of the present invention, the alloy comprises: (A) one or more of the transition metal elements; (B) aluminum; (C) one or more of the group 1A alkali metal elements; and (D) one or more elements and/or compounds having high mobility values for electrons.

In another type of alloy of the present invention, the alloy comprises: (A) one or more of the transition metal elements; (B) aluminum; (C) no alkali metal elements; and (D) one or more elements and/or compounds having high mobility values for electrons.

In yet another type of alloy of the present invention, the alloy comprises: (A) one or more of the transition metal elements; (B) no aluminum; (C) one or more of the group 1A alkali metal elements; and (D) one or more elements and/or compounds having high mobility values for electrons.

The alloys are also designed to release hydrogen gas in a controlled and useful fashion upon contacting the alloys with water. Therefore, these alloys may be used in many of the well-established applications for hydrogen gas, for example, in internal combustion engines, heating, ion propulsion, magnetohydrodynamics (MHD), fuel cells, welding, hydrogenation of oils, hydrogenation of petroleum and petrochemical fuels, hydrogenation of polymer related materials, reduction of organic compounds, reduction of inorganic and organometallic compounds, hydrogenation of volatile materials in vapor deposition processes, conventional jet propulsion, rocket fuel, and other applications.

The alloys of the present invention may also serve as both an electrode and a fuel source, and be used in hybrid fuel cells. The alloys of the present invention may also be used in a new capacitor which both stores and generates electrical energy. The present alloys are also useful as anode materials in a number of applications, such as in batteries, fuel cells, capacitors, and hybrid battery/fuel cell designs.

### Definitions

In order to more clearly define the various terms as used herein, the following definitions are provided.

The term “composition” and such variations as “alloy” and “alloy composition” are used herein to mean the alloy as defined by the components described below. Thus, alloys of the present invention comprise the following components: (A) one or more of the transition metal elements; at least one of either (B) aluminum or (C) one or more of the group 1A alkali metal elements; and (D) one or more elements and/or compounds having high mobility values for electrons.

Thus, the term “composition” and such variations as “alloy” and “alloy composition” are used herein to refer to all the types of alloys of the present invention, for example, alloys comprising: (A) one or more of the transition metals; (B) aluminum; (C) one or more of the group 1A alkali metals; and (D) one or more elements and/or compounds having high mobility values for electrons. The terms “composition” and such variations as “alloy”, and “alloy composition” are also used herein to mean alloys comprising (A) one or more of the transition metal elements; (B) aluminum; (C) no alkali metal elements; and (D) one or more elements and/or compounds having high mobility values for electrons. The terms “composition” and such variations as “alloy”, and “alloy composition” are also used herein to mean alloys comprising: (A) one or more of the transition metal elements; (B) no aluminum; (C) one or more of the group 1A alkali metal elements; and (D) one or more elements and/or compounds having high mobility values for electrons.

The term “transition metal” and such variations as “transition metal element” and “transition element,” as used herein, refer to the metals in groups 1B, 2B, 3B, 4B, 5B, 6B, 7B, and 8B, of the periodic table of elements, referring specifically to the elements scandium, yttrium, lanthanum, actinium, titanium, zirconium, hafnium, vanadium, niobium, tantalum, chromium, molybdenum, tungsten, manganese, technetium, rhenium, iron, ruthenium, osmium, cobalt, rhodium, iridium, nickel, palladium, platinum, copper, silver, gold, zinc, cadmium, and mercury. These elements are also described in the present application by their common one or two letter abbreviations known to one of ordinary skill in the art.

The terms “group 8B metal” or “8B metal,” as used herein, refer to the metals iron, ruthenium, osmium, cobalt, rhodium, iridium, nickel, palladium, and platinum.

The terms “group 1A alkali metal” and such variations as “group 1A metal” and simply “alkali metal,” as used herein, refer to the metals in group 1A of the periodic table, namely Li, Na, K, Rb, Cs, and Fr.

The term “high electron mobility” element, compound, material, or component, and such variations as materials “having high mobility values for electrons” or “semiconductors,” as used herein, refer to species characterized by an electron mobility value from about 100 cm²/V·s to about 100,000 cm²/V·s. Examples of these species, which typically comprise semiconductor materials, include, but are not limited to C, Si, Ge, Sn, AgBr, CdTe, HgSe, HgTe, AlAs, GaAs, GaSb, InP, InAs, InSb, SiC, ZnSiP₂, CdSiP₂, CdSnAs₂, CdIn₂Te₄, Hg₅In₂Te₈, PbSe, PbTe, Bi₂Te₃, and Te.

The term “intermetallic compound” and such variations as “intermetallic species,” as used herein, refer to a compound that may form from the reaction of at least two of the components of the alloy, namely, the transition metal component, aluminum, the group 1A alkali metal component, and the high electron mobility component. The particular intermetallic compound that may form depends upon many factors, including, but not limited to, the identity of components (A), (C), and (D) selected for the alloys, the relative proportions of the materials recited in (A, B, C and D) in the alloys, and the conditions under which the alloys are formed. Examples of possible intermetallic compounds include, but are not limited to AlNi, Al₃Ni₅, Al₄Li₉, AlSb, Al₃Ni, Ni₅Ge₃, Ni₃Ge, Ni₂Ge, Ni₅Ge₂, Ni₂₈In₇₂, NiSb₂, Ni₂In₃, Li₃Sb, Li₃Sb₂, Li₁₅Pd₄, Li₂Pd, Li₃Pd, Li₂Sn₅, In₃Li₁₃, InSb, InLi₃, InLi, InLi₂, In₃Li₁₃, PdSb₂, PdSn₄, GePd₂, Ge₅Li₂₂, and Sn₃Sb₂.

### Alloy Compositions

The alloy compositions of the present invention are described by their components and the weight percentages of each component. It is to be understood that these recited percentages are percents by weight of each alloy component with respect to the weight of a final composition assumed to contain only these cited components. Thus, while additional components may be added to the alloys of the present invention, the stated weight percentages are relative to the portion of the final alloy containing only these components. It is to be understood that the inclusion of additional ingredients is encompassed within the present invention, depending upon the application for which a particular alloy is intended, provided the additional ingredients do not adversely affect the function of the alloy. It is also to be understood that the weight percentages recited herein include weights that are about 10% above or below the actual weight represented by that percentage.

In general terms, the alloys of the present invention comprise the following components: (A) one or more of the transition metal elements; at least one of either (B) aluminum or (C) one or more of the group 1A alkali metal elements; and (D) one or more elements and/or compounds having high mobility values for electrons. Thus, components A, D, and at least one of components B and C are necessary ingredients of the present invention. While not wanting to be bound by the following statement, it is believed that because these components are processed into the alloys of the present invention by melting, intermetallic compounds may form as a result of reactions between at least two of these components.

Intermetallic compounds can vary over a wide range of compositions because the particular intermetallic compound that may form depends upon many factors, including, but not limited to: the identity of individual components selected for the alloy; the relative proportions of the component materials used in the alloys; and the conditions under which the alloys are formed.

An examination of the metallurgical phase diagrams for selected elements or compounds recited as components A, B, C, or D suggests that large macrosegregation domains will result from the limited solubilities of the components in their desired percentages. The present invention provides a method of manufacturing the alloys that reduces macrosegregation and develops homogeneity in an otherwise nonhomogeneous system.

In all the embodiments described herein, percentages are expressed by weight, unless otherwise specified. In general, the one or more of the transition metals of the present invention are present in about 1% to about 80% of the composition by weight. The aluminum is present in an amount from about 2% to about 95% by weight of the alloy composition. The one or more of the group 1A alkali metals component is present in an amount from about 1% to about 90% by weight of the composition. The one or more elements and/or compounds having high mobility values for electrons component is present in the alloy composition in an amount from about 3% to about 82% by weight. The amount of each component used in an embodiment of the alloy depends on, among other things, the anticipated use of that alloy. Guidelines for determining the amount of each component are provided below.

In one embodiment of the present invention, wherein the alloy comprises components A, B, C, and D recited above, the approximate weight percentages of the alloy components are about 60% nickel, about 20% aluminum, about 10% lithium, and about 10% germanium.

In another embodiment of this invention, wherein the alloy comprises components A, B, C, and D recited above, the alloy comprises about 6% nickel, about 20% aluminum, about 10% lithium, about 29.1% indium, about 30.9% antimony, and about 4% germanium.

In yet another embodiment of this invention, wherein the alloy comprises components A, B, C, and D recited above, the alloy comprises about 10% nickel, about 20% aluminum, about 10% lithium, about 29.1% indium, and about 30.9% antimony.

In yet another embodiment of the present invention, wherein the alloy comprises components A, B, C, and D recited above, the alloy comprises about 6.7% nickel, about 8.5% palladium, about 3% aluminum, about 1.5% lithium, about 18.8% indium, about 20% antimony, about 3.5% germanium, and about 38% tin.

In still another embodiment of the present invention, wherein the alloy comprises components A, B, C, and D recited above, the alloy comprises about 6.7% nickel, about 26.65% aluminum, about 25.15% sodium, about 3.5% germanium, and about 38% tin.

In another embodiment of the present invention, wherein the alloy comprises components A, B, C, and D recited above, the alloy comprises about 62.07% sodium, about 24.28% aluminum, about 5.00% nickel, and about 8.65% indium antimonide.

Yet another embodiment of this invention, wherein the alloy comprises components A, B, C, and D recited above, is an alloy comprising about 41.38% sodium, about 48.56% aluminum, about 5.00% nickel, and about 5.06% indium antimonide.

In another embodiment of the present invention, wherein the alloy comprises components A, B, C, and D recited above, the alloy comprises about 62.07% sodium, about 24.28% aluminum, about 2.5% nickel, about 2.5% palladium or 2.5% platinum, and about 8.65% indium antimonide.

Yet another embodiment of this invention, wherein the alloy comprises components A, B, C, and D recited above, is an alloy comprising about 41.38% sodium, about 48.56% aluminum, about 2.5% nickel, about 2.5% palladium or 2.5% platinum, and about 5.06% indium antimonide.

In yet another embodiment of the present invention, wherein the alloy comprises components A, B, and D recited above, the alloy comprises about 90% aluminum, about 5% nickel, and about 5% germanium.

Another embodiment of the present invention, wherein the alloy comprises components A, C, and D recited above, is an alloy comprising about 90% lithium, about 5% nickel, and about 5% indium antimonide.

The alloys of the present invention are prepared by combining and melting the components of the alloys in a standard arc melting furnace, induction furnace, vapor deposition chamber, or sintering furnace using techniques known to one of ordinary skill in the art. In some embodiments of this invention, it is desirable to form intermediate or pre-melt alloys comprising a subset of the alloy components, and subsequently use the intermediate alloy(s) in a melting step along with the remaining alloy components. Typically, sufficient physical agitation accompanies the arc melting process to afford the preferred high sample homogeneity. While some physical agitation accompanies the induction melting process, it may or may not be necessary to apply additional physical agitation and/or sonication treatments to the melted sample to achieve the preferred high sample homogeneity. These treatments are made during the cooling step while the pre-melt alloy or final melt alloy sample is still in the liquid state.

In order to produce hydrogen gas from the alloys of the present invention, the alloys are contacted with either water or aqueous hydroxide ion. In alloys that contain group 1A alkali metals, it is only necessary to add water to activate the sample to produce hydrogen. In alloys of the present invention that do not contain alkali metals, it is necessary to add aqueous hydroxide ion, e.g. aqueous potassium hydroxide, to activate the sample to produce hydrogen. The alloy compositions of the present invention release hydrogen and energy over a period of a few hours to a few weeks when activated in this fashion. In addition, the alkali metal hydroxide and/or aluminum hydroxide, formed upon activating the alloy, create an electrolytic solution for various electrical applications in which the alloy compositions serve as electrodes.

It is also known that aluminum reacts with hydroxide ion under various conditions to form hydrogen. Because some alloys of the present invention contain aluminum and/or at least one group 1A alkali metal, hydrogen production may arise from reactions of both these components.

### Selection of Alloy Components

The examples contained herein are illustrative of the alloys of the present invention and are not to be construed as limiting in any way either the spirit or scope of the present invention.

Group 1A Alkali Metal Component and Aluminum

There are several guidelines for selecting the components of the alloys of the present invention and their relative proportions. It is convenient to describe the weight percentages of alkali metal plus aluminum in an alloy, and these percentages apply to those alloys that contain both of these components, as well as those alloys that contain only aluminum or only alkali metal.

It is believed that aluminum and the group 1A alkali metals are the principal alloy components that react to release hydrogen gas. Therefore, more hydrogen is generated from the alloy compositions that contain a higher proportion of these two components. In an embodiment designed to maximize the amount of hydrogen produced per unit weight of alloy, the weight percent of alkali metal plus aluminum can be about 95% of the entire composition by weight. In an embodiment designed for a slower rate of hydrogen gas release, the weight percent of alkali metal plus aluminum can be about 4% of the entire composition by weight. Relatively low percentages of alkali metal plus aluminum minimize the safety risk of accidentally contacting the alloys with water. Alloy compositions within this entire range of 4% to 95% are operative, and the weight percent of alkali metal plus aluminum can be adjusted to either maximize hydrogen production or moderate the rate of hydrogen gas release.

A preferred weight percent of group 1A alkali metal plus aluminum is therefore from about 4% to about 95% of the entire composition. In an embodiment designed to maximize the amount of hydrogen produced per unit weight of alloy, a more preferred weight percent of alkali metal plus aluminum is from about 50% to about 95%, with a more preferred weight percent of from about 80% to about 95% of the entire composition.

In an embodiment designed to moderate the rate of hydrogen gas release, a more preferred weight percent of alkali metal plus aluminum is from about 4% to about 50% of the entire composition, with a most preferred weight percent of from about 30% to about 50%.

In addition to the weight percentage of group 1A alkali metal and aluminum to the total alloy weight, the relative ratio of these components to each other can be important in formulating those alloy compositions that contain both components. In this case, it is convenient to describe the ratio of alkali metal to aluminum in terms of their mole ratio or atomic ratio. The alkali metal:aluminum mole ratio can vary from about 10:1 to about 1:10, and the mole ratios can be adjusted continuously in this range. A preferred mole ratio of the alkali metal:aluminum is from about 5:1 to about 1:5, with a more preferred mole ratio of from about 3:1 to about 1:3, with a yet more preferred mole ratio of from about 3:1 to about 1:1. Two most preferred mole ratios of the alkali metal:aluminum are about 3:1 and about 1:1.

In selecting the group 1A alkali metal component of those alloys of the present invention that contain an alkali metal, factors such as the extent of metallurgical solubility of the alkali metal in the other alloy components, the relative expense of the alkali metal, and the possibility of forming intermetallic compounds with other alloy components are all considerations that may affect the choice of alkali metal. Thus, the preferred group 1A alkali metals are lithium, sodium, potassium, rubidium, and cesium. The more preferred alkali metals are lithium, sodium, and potassium. The still more preferred alkali metals are lithium and sodium. The most preferred alkali metal with respect to its solubility in aluminum, is lithium. Any of these alkali metals may be used alone or in combination with other alkali metals in those alloys of the present invention that contain an alkali metal.

Transition Metal Elements

The alloys of the present invention also comprise one or more of the transition metal elements, namely one or more of the groups 1B, 2B, 3B, 4B, 5B, 6B, 7B, and 8B elements. These elements include scandium, yttrium, lanthanum, actinium, titanium, zirconium, hafnium, vanadium, niobium, tantalum, chromium, molybdenum, tungsten, manganese, technetium, rhenium, iron, ruthenium, osmium, cobalt, rhodium, iridium, nickel, palladium, platinum, copper, silver, gold, zinc, cadmium, and mercury.

Preferably, the transition metal component of the alloys of the present invention comprises one or more of the transition metals iron, ruthenium, osmium, cobalt, rhodium, iridium, nickel, palladium, platinum, silver or gold. More preferably, the transition metal component of the alloys comprises one or more of nickel, palladium, platinum, silver or gold. More preferably still, the transition metal component of the alloys comprises one or more of nickel, palladium or platinum. Most preferably, the transition metal component of the alloys of the present invention comprises nickel.

Nickel is the preferred transition metal for several reasons, including its resistance to corrosion by alkalis, its high catalytic activity, and its relative cost as compared with other transition metals. Other transition metal elements, particularly palladium, platinum, silver, and gold, are also useful either by themselves or in combination with nickel. As circumstances change, such as the relative cost of a transition metal element, the use of other transition elements may be more preferred.

Component Having a High Mobility Value for Electrons

The alloys of the present invention also comprise one or more elements or compounds having high mobility values for electrons. Although these elements or compounds are also referred to herein as semiconductors, the preferred method of characterizing them is with respect to their actual electron mobility values. Semiconductor materials that are operative in the alloys of the present invention include, but are not limited to C, Si, Ge, Sn, AgBr, CdTe, HgSe, HgTe, AlAs, GaAs, GaSb, InP, InAs, InSb, SiC, ZnSiP₂, CdSiP₂, CdSnAs₂, CdIn₂Te₄, Hg₅In₂Te₈, PbSe, PbTe, Bi₂Te₃, and/or Te. Table 1 (adapted from the CRC Handbook of Chemistry and Physics, David R. Lida, Editor-in-Chief, CRC Press, 71st Ed., 1990-91) presents the electron mobility values for many of these elements and compounds. The selection of high electron mobility components among the possible choices may be aided by considering their electron mobility values, their compatibility with the other alloy components, their stability in the presence of oxygen, water, and hydrogen, and their relative expense.

While materials having relatively low electron mobilities may be used in the present invention, components having electron mobilities between about 100 cm²/V·s and about 100,000 cm² V·s are preferred. More preferred are components having electron mobilities between about 400 cm²/V·s and about 100,000 cm²/V·s. More preferred still are those components having electron mobilities between about 800 cm²/V·s and about 100,000 cm²/V·s. Most preferred are elements and compounds having electron mobilities between about 1,000 cm²/V·s and about 80,000 cm²/V·s. Elements and compounds selected for this alloy component may be used either by themselves or in combination with additional high electron mobility components. One preferred combination of materials having a high mobility value for elections is Ge and InSb.

TABLE 1
Non-limiting Examples of Elements or Compounds Characterized
by a High Electron Mobility Value

| MATERIAL | ELECTRON MOBILITY (cm²/V · s) |
|---|---|
| C—Carbon | 1800 |
| Si—Silicon | 1900 |
| Ge—Germanium | 3800 |
| Sn—Tin | 2500 |
| AgBr—Silver Bromide | 4000 |
| CdTe—Cadmium Telluride | 1200 |
| HgSe—Mercury Selenide | 20000 |
| HgTe—Mercury Telluride | 25000 |
| AlAs—Aluminum Arsenide | 1200 |
| GaAs—Gallium Arsenide | 8800 |
| GaSb—Gallium Antimonide | 4000 |
| InP—Indium Phosphide | 4600 |
| InAs—Indium Arsenide | 33000 |
| InSb—Indium Antimonide | 78000 |
| SiC—Silicon Carbide | 4000 |
| ZnSiP₂ | 1000 |
| CdSiP₂ | 1000 |
| CdSnAs₂ | 22000 |
| CdIn₂Te₄ | 4000 |
| Hg₅In₂Te₈ | 2000 |
| PbSe—Lead Selenide | 1000 |
| PbTe—Lead Telluride | 1600 |
| Bi₂Te₃—Bismuth Tritelluride | 1140 |
| Te—Tellurium | 1700 |

Preferred semiconductor materials, include, but are not limited to C, Si, Ge, Sn, AgBr, CdTe, HgSe, HgTe, AlAs, GaAs, GaSb, InP, InAs, InSb, SiC, ZnSiP₂, CdSiP₂, CdSnAs₂, CdIn₂Te₄, Hg₅In₂Te₈, PbSe, PbTe, Bi₂Te₃, and/or Te. More preferred semiconductor materials, when using nickel as the transition metal component of the alloys, are Ge, Sn, and InSb. An even more preferred semiconductor material when using nickel as the transition metal component of the alloys is Ge, In or Sb. A most preferred semiconductor material when using nickel as the transition metal component of the alloys is Ge. Note that the semiconductor material selected for the alloys may be used either by itself or in combination with additional high electron mobility components. A preferred combination of semiconductor materials in the alloys is Ge, InSb, and Sn. A more preferred combination of semiconductor materials in the alloys is Ge and InSb.

Intermetallic Compounds

While not wanting to be bound by the following statements, because the alloys of the present invention are processed by melting, intermetallic compounds may form as a result of reactions between at least two of these components. It is also possible that reactions among three or more components may result in intermetallic compounds containing more than two components. An indication of possible intermetallic compounds is obtained by inspecting the alloy phase diagrams for various combinations of alloy components, such as those found in Binary Alloy Phase Diagrams, 2d Ed., Vols. 1-3, T. M. Massalski (ASM International, 1990).

By way of example, in an alloy containing nickel, aluminum, lithium and germanium, inspecting the Al-Ge, Al-Li, Al-Ni, Ge-Li, Ni-Ge, and Li-Ni binary alloy phase diagrams reveals that several intermetallic compounds may form under certain conditions, including, but not limited to, Al₂Li₃, Al₄Li₉, AlNi, Al₃Ni, Al₃Ni₂, Al₃Ni₅, Ni₃Ge, Ni₃Ge₂, Ni₅Ge₃, Ni₂Ge, and Ge₅Li₂₂,

The particular intermetallic compound that may form depends upon many factors, for example, the identify of transition metal, alkali metal, and high electron mobility components selected for the alloy, and the relative proportions of these components. The particular conditions under which the alloy is manufactured or processed also affects the formation of intermetallic compounds. While not intended to be an exhaustive listing, examples of intermetallic compounds include, but are not limited to, AlNi, Al₃Ni₅, Al₄Li₉, Al₃Ni, AlSb, Ni₅Ge₃, Ni₃Ge, Ni₂Ge, Ni₅Ge₂, Ni₂₈In₇₂, NiSb₂, Ni₂In₃, Li₃Sb, Li₃Sb₂, Li₁₅Pd₄, Li₂Pd, Li₃Pd, Li₂Sn₅, In₃Li₁₃, InSb, InLi₃, InLi, InLi₂, In₃Li₁₃, PdSb₂, PdSn₄, GePd₂, Ge₅Li₂₂, and Sn₃Sb₂.

### Manufacturing and Processing the Alloys of the Present Invention

An examination of the metallurgical phase diagrams for components and possible components of the alloys of the present invention suggests that large macrosegregation domains will result from the limited solubilities of these components in their desired percentages. Metallalurgical phase diagrams for these components are reported in Binary Alloy Phase Diagrams, 2d Ed., Vols. 1-3, T. M. Massalski, (ASM International 1990), which is incorporated herein by reference. Therefore, the present invention also provides methods of manufacturing the alloy compositions that reduce macrosegregation and that develop a higher degree of homogeneity than would otherwise be possible.

General Manufacturing Procedures

One concern during the manufacture of the alloys of the present invention is the introduction of potential contaminants, with special attention directed to preventing the introduction of oxygen or water during the manufacturing process. In order to reduce the presence of contaminants, steps were taken to minimize the exposure of the alloy components to reactants such as air or moisture in order to minimize the formation of oxide, hydroxide, and other contaminants.

Therefore, storage, processing, and manipulation of the alloy components, melts, and final alloys were typically carried out either under vacuum or in an inert atmosphere, such as argon. Methods of handling air- and moisture-sensitive compounds are well known to one of ordinary skill in the art as described in the treatise, The Manipulation of Air-Sensitive Compounds, by D. F. Shriver and M. A. Drezdon, 2d ed., John Wiley and Sons: New York (1986), which is incorporated herein by reference. While there are several methods of handling samples under vacuum or in an inert atmosphere, the components of the present invention were typically handled under argon in an inert atmosphere glove box, such as an Aldrich #Z19,671 -1, Z40,3769-2, or Z19,429-8 glove box (Milwaukee, Wis.). When samples were removed from the glove box, transferred to the reaction furnace or chamber, and returned to the glove box after melting, they were typically maintained under an inert atmosphere as much as possible.

Alloys of the present invention can be prepared by melting the alloy components in an arc melting furnace, an induction melting furnace, a vapor deposition chamber, a sintering furnace, or other similar methods that are capable of melting the components of the alloy, such methods being well known to one of ordinary skill in the art. While the particular sample containers and crucibles vary among these methods of melting, in all cases the alloy components, melts, and final alloys were typically manipulated either under vacuum or in an inert atmosphere, such as argon, depending upon the sample container and furnace/chamber design. These methods and practices are well known to one of ordinary skill in the art.

In addition, high purity components were utilized in the present invention to minimize the introduction of existing contaminants in the alloy components that might interfere with the efficient operation of the alloy. While not required to obtain alloy activity, using high purity components enhanced the efficiency of the use of the alloy.

After melting the alloy components, some type of physical agitation or stirring is typically applied to assist in achieving a high degree of homogeneity in the sample. The agitation treatments are made while the sample is still in the liquid state. For example, a high degree of physical agitation of the melt accompanies the arc melting process and, to a lesser extent, induction melting. In the case of arc melting, it is typically not necessary to provide any further agitation steps of any kind beyond that inherent in the process itself. For induction melting, additional agitation is useful, but not necessary.

Commercially available sonication units are employed to sonicate the melts at ultrasonic frequencies. The utility of sonication is illustrated by the formation of alloys of lead-aluminum and lead-tin-zinc using ultrasonic techniques, which are difficult to prepare by conventional metallurgical techniques because of the relative insolubility of these metals in each other. In practice, during both the pre-melt(s) and the final melt of these alloys, high frequency sonication is used during the cooling stage, while the metals/compounds are in a liquid state. With rapid cooling, relatively homogeneous alloys are produced.

An audio frequency agitation process, utilizing either speakers or piezos, is also optionally applied to the liquid sample during the cooling step on both the pre-melt and the final melt, to achieve a high degree of physical agitation. As is known in the art, typical audio frequencies are in the range of from 1 Hz to 32,000 Hz. A wave function generator is connected to a preamplifier which is connected to an audio amplifier, with output either through speakers or piezos, with a power range of from 15 to 30 watts, with more power being applied to larger samples. As in other agitation methods, audio frequency stirring is used on both pre-melts and final melts of the alloys while the sample is still in the liquid state.

The sonication and/or agitation treatments are applied to the alloys while maintaining the samples under an inert atmosphere. While it is not necessary to employ both audio frequency agitation and sonication treatments to every alloy, the ability to impart physical perturbation at different frequencies proves useful to achieve homogeneity for different samples. After cooling is complete such that the sample can be handled safely, the crucible is transferred to an inert atmosphere in a glove box to minimize exposure of the sample to the air during further processing.

Any conventional heat treatment or method known to one skilled in the art to reduce macrosegregation within alloys may be employed to improve homogeneity of the alloy samples of the present invention. As an option, and depending upon the final application of a particular alloy sample, special cooling techniques are utilized to improve the final product. For example, rapid cooling methods, such as pouring the alloy samples over a cold drum, or maintaining the samples in a cold copper crucible, are all practical methods that allow for the rapid cooling of samples, which often provide amorphous as opposed to crystalline samples.

After melting, the gas/vacuum handling system of the particular furnace and crucible is used to place the samples under an inert atmosphere or under vacuum, for further processing. Typically, the samples are transferred back to a glove box for further processing. All post-preparatory procedures, such as machining the alloy samples, weighing the samples, refractory coating of crucibles (if appropriate), and sealing and storing samples in suitable storage containers, are also carried out under an inert atmosphere.

Arc Melting

The arc melting furnace, as used in the present invention, includes a system of melting elements, compounds, alloys, etc., through the use of a high current potential being developed between two juxtaposed electrodes. A typical arc melting system includes a vacuum chamber, a cold copper plate/crucible that functions as both an electrode surface and a surface in which the melting is achieved, an upper movable electrode which can be located near the plate/crucible, and a power supply.

The arc melting system of the present invention involves the following steps. The alloy components, which were stored and processed under an inert atmosphere, were loaded into an arc melting crucible and then placed into the vacuum chamber portion of the arc melting furnace with minimal exposure of the sample to the atmosphere. The vacuum chamber was sealed, placed under a dynamic vacuum for several minutes and then refilled with argon. This pump and refill cycle was repeated one or two more times to achieve thorough removal of any remaining gaseous contaminants from the chamber. The upper, moveable electrode was placed into position and the furnace was powered to achieve an arc to meet the sample.

In some alloys it was desirable to form intermediate alloys or “pre-melts” comprising a subset of the alloy components, and thereafter use the intermediate alloy(s) in a subsequent arc melting step along with the remaining alloy components. When pre-melts were used, each pre-melt alloy was handled and processed in the same fashion as a final melt alloy. Thus, after a pre-melt, the intermediate alloy was cooled until it could be handled safely, combined with the remaining alloy components, and then subjected to the arc melting furnace in the same manner. The Examples presented herein illustrate some of the specific pre-melts alloys used in the present invention.

Typically, sufficient physical agitation accompanies the arc melting process to afford the preferred high sample homogeneity. In one embodiment of this invention, an arc melting furnace is fitted with mixing, agitation, or sonication equipment, as described above, After cooling was complete such that the sample could be handled safely, the crucible was transferred to an inert atmosphere in a glove box to minimize exposure of the sample to the air during further processing.

Any conventional heat treatment or method known to one skilled in the art to reduce macrosegregation within alloys may be employed to improve homogeneity of the alloy samples of the present invention.

Induction Melting

As known to one of ordinary skill in the art, induction melting as used in the present invention includes a method of melting elements, compounds, alloys, etc., through the use of a high current, high frequency potential being developed in a copper coil. An insulated crucible, with an example being a graphite tube crucible with a quartz sheath, is placed in the inner diameter of the copper coil. Typical induction melting equipment includes a power supply (4 KHz and above), various diameter copper coils, and glove box/vacuum chambers if necessary.

Induction melting typically involves placing the alloy components in an insulated graphite crucible in a quartz sheath which was then placed in the inner diameter of the copper coils of the induction melting furnace under an inert atmosphere. Melting was accomplished under a blanket of argon gas (1 atmosphere pressure). The induction melting furnace was powered until the sample was completely melted, usually for several minutes depending upon sample size. Power to the furnace was then removed once the sample was allowed to cool until it could be handled safely.

As described above for the arc melting procedure, it is often desirable to prepare pre-melts comprising a subset of the alloy components, and thereafter use the pre-melt alloy in an induction melting step along with the remaining alloy components. When pre-melts were used, each pre-melt alloy was handled and processed in the same fashion as a final melt alloy. The induction melting procedure optionally utilized a series of physical agitation and/or sonication treatments to achieve a high degree of homogeneity in the sample as described above. Any conventional heat treatment or other methods known to one skilled in the art may be utilized to reduce macrosegregation within the alloys, as described above for arc melting.

Vapor Deposition

Vapor deposition, as used in the present invention, refers to methods in which materials (elements, compounds, alloys, etc.) are vaporized into the gas phase and then condensed or deposited onto a substrate (ceramic, plastic, etc.) through the use of a combination of vaporizing beam and target. As well known to one of ordinary skill in the art, a variety of vapor deposition techniques are available. For example, one vapor deposition technique utilizes an electron beam which strikes a metal target (e.g. aluminum) with a known amount of energy, thereby imparting sufficient energy to that target to cause an amount of material to leave the target surface and become a vapor. This vapor is then deposited onto a given substrate at a known thickness and rate.

With respect to the present invention, vapor deposition involves the following steps. First, the alloy components were processed under an inert atmosphere (in a glove box) into the proper form (size, shape, etc.) to constitute a target for the particular vapor deposition equipment being used. Once in the proper form, the vapor deposition target(s) are transferred to the vacuum chamber portion of the deposition equipment, while maintaining the target material under an inert atmosphere to the extent possible. To accomplish this task, the target(s) may simply be packaged in an airtight, argon filled container for transfer to the deposition chamber. The vapor deposition chamber is sealed, a vacuum is created, and the chamber is maintained under a high vacuum during the vapor deposition process.

Just as the pre-melts were desirable in the melting procedures described above, it may be desirable in the vapor deposition process to utilize a series of pre-sputters and alloy layers, before the final sputter. By way of example, in an alloy of the present invention comprising nickel, aluminum, lithium and germanium, one method of alloy manufacture uses three separate sputtering targets, one target of nickel-aluminum alloy, a second target of lithium, and a third target of germanium. During a pre-sputter process, a primer layer of one of these elements or alloy is applied to the substrate to yield a desired beneficial effect for the final sample, such as good adhesion to the substrate. Next, the final sputter utilizes all three targets to build up a coating of the final alloy. The final sputter step is repeated until the desired thickness of the alloy has been attained.

One advantage of sputtering over conventional metallurgical techniques is that extremely homogeneous samples may be obtained. Because the layers of material applied may be made extremely thin (approximately 100 angstroms) and because the time involved for the sample to cool is extremely rapid, the problems of homogeneity in this alloy system are virtually eliminated. As known to one of ordinary skill in the art, certain treatments and conditioning procedures may be made to the substrate to help insure homogeneity in this alloy system.

A further advantage of sputtering over conventional metallurgical techniques is the ability to apply protective coatings to a final alloy sample. For example, it is often desirable to apply a protective layer to the final alloy sample, for example a silicone layer, to prevent the alloy sample from reacting with the moisture in the ambient air. The vapor deposition process is well adapted to achieve this goal.

Sintering

In addition to the arc melting, induction melting, and vapor deposition techniques described above, the alloys of the present invention may be manufactured by the process of sintering. This method, which is well known to one of ordinary skill in the art, involves thorough mixing of the components of the final alloy, in the proportions desired in the final alloy. The ingredients are mixed in the form of powders until a homogeneous mixture is obtained. Pressure is then applied to a sample of this mixture at pressures from about 10,000 to 100,000 pounds per square inch using, for example, a steel dye. The compressed material is then heated in an oven at sufficiently high temperatures to fuse the alloy.

### Use of the Alloy Compositions for Electrode Materials

Battery Anode Comprising the Alloys of the Present Invention

The alloys of the present invention are utilized in a battery that is designed and constructed according to standard battery designs known to one of ordinary skill in the art. Batteries of this design, employing the alloys of the present invention, are capable of achieving high energy densities. The anode of such a battery comprises the alloy composition of the present invention, and the cathode of the battery comprises any common cathode material, typically carbon, the selection and design of which are well known to one skilled in the art. One example of cathode material that may be used in a battery is the carbon electrode found in zinc-air batteries.

By way of example, an electrolyte such as an aqueous alkali metal salt is used, although the present invention anticipates the use of solution, paste, and other types of electrolytes known to one of ordinary skill in the art. If the alloy of the present invention used to make the anode contains an alkali metal, then any suitable soluble salt well known to one of ordinary skill in the art is used in the aqueous electrolyte. If the alloy of the present invention used to make the anode does not contain an alkali metal, then a salt containing hydroxide ion, typically potassium hydroxide, is used in the aqueous electrolyte.

Capacitor Anode Comprising the Alloys of the Present Invention

The alloys of the present invention may also be used in a capacitor/battery device of similar design as hybrid capacitor/battery devices in the relevant art, to achieve high energy densities. In such devices, the anode of this capacitor/battery is typically made of a combination anode comprising the alloy of the present invention and high surface area carbon foams as used in super capacitor or ultra capacitor technologies known to one of ordinary skill in the art.

The composite is constructed such that samples of alloy anode and carbon foam materials are brought into intimate contact along one edge of each material, such that a single monolith comprising two portions is formed. Alternatively, a carbon foam electrode that is impregnated with the alloy composition of the present invention may be employed. One carbon foam employed in such capacitor devices is manufactured by Mitsushita (Kyoto, Japan) and utilized in the Panasonic super capacitor EECA OEL 106 rated at 2.5 V at 10 farads. The cathode of the capacitor comprises any common cathode material, typically carbon, the selection and design of which are well known. One example of cathode material is the carbon electrode found in zinc-air batteries. A dielectric material separating the anodic and cathodic half-cells is typically used, depending upon the particular capacitor design.

An electrolyte such as an aqueous alkali metal salt is used, although the present invention anticipates the use of solution, paste, and other types of electrolytes known to one of ordinary skill in the art. If the alloy of the present invention used to make the anode comprises an alkali metal, then any suitable soluble salt well known to one of ordinary skill in the art may be used in the aqueous electrolyte. If the alloy of the present invention used to make the anode does not contain an alkali metal, then a salt containing hydroxide ion, typically potassium hydroxide, is used in the aqueous electrolyte.

The difference between the battery and the capacitor hybrid is that electrons from the alloy begin to accumulate along the surface of the carbon foam. Due to the high surface area of the carbon foam material and its operating characteristics, a high peak current is possible when discharging this device through a load. This hybrid capacitor device, like a capacitor, may be recharged from an external power source, however, this capacitor hybrid recharges itself over time as a result of the battery incorporated within its design.

Fuel Cells Comprising the Alloys of the Present Invention

The alloys of the present invention were utilized in a hybrid battery/fuel cell that was designed and constructed according to standard fuel cell designs known to one skilled in the art, to achieve high energy densities. The anode of the fuel cell was constructed in one of two ways. In one embodiment, the anode comprised the alloy composition of the present invention, in contact with a standard platinum black electrode. Moreover, these two anode components are disposed where the hydrogen gas produced at the alloy portion of the anode contacted the platinum black portion of the anode and thereby served as a fuel for the fuel cell. In a second embodiment, the anode comprised the alloy of the present invention, wherein the alloy contained platinum as one of its components. Thus, the platinum served to convert the hydrogen to water in the operation of the fuel cell.

The cathode of the fuel cell comprised any common fuel cell cathode material, the selection and design of which are well known to one of ordinary skill in the art. The cathode was contacted with oxygen that comprised the oxidant for the fuel cell system and was itself reduced to hydroxide during the operation of the fuel cell. An aqueous electrolyte comprising an alkali metal salt was used in this system. If the alloy of the present invention used to make the anode contains an alkali metal, then any suitable soluble salt may be used in the aqueous electrolyte, the selection of which is well known to one of ordinary skill in the art. If the alloy of the present invention used to make the anode does not contain an alkali metal, then a salt containing hydroxide ion, typically potassium hydroxide, must be used in the aqueous electrolyte.

When the alloy anode of the present invention came into contact with the aqueous electrolyte, reaction between the electrolyte and the alloy initiated, and hydrogen was produced. The hydrogen was used in the direct production of energy in this fuel cell system, thus, hydrogen was oxidized at the anode and oxygen was reduced at the cathode.

The alloys of the present invention were also utilized in conjunction with a traditional fuel cell design by employing it solely as a source for hydrogen gas. Thus, upon contacting the alloy compositions of the present invention with water, or aqueous alkali metal hydroxide solutions, hydrogen gas was produced that was utilized by contacting it with the anode of a traditional hydrogen fuel cell system, designs of which are well known to those of skill in the art.

Emergency Radio Powered by the Alloy Composition of the Present Invention

A battery or similar power source (1 Watt) is required to power a radio transmitter, such as a SARBE 5 Rescue radio transmitter, used in emergency or recovery situations. Using currently available power sources such as a conventional 12.15 volt battery, for example a BE375 12.15 volt battery, continuous operating time for this transmitter is only about 1 hour. In addition, the shelf life of conventional batteries, such as the BE375 battery, can limit their utility. A battery made with an alloy of the present invention addresses the limitations of conventional batteries by remaining inert when not in use, thereby greatly extending its shelf life, because the battery is not activated until the time of its use. Thus, the battery may be stored for long periods of time until it is needed, at which time it can be activated by the addition of water or aqueous hydroxide ion, depending upon whether the alloy contains alkali metal (water only) or not (aqueous hydroxide).

The present invention is further illustrated by the following examples, which are not to be construed in any way as imposing limitations upon the scope thereof. On the contrary, it is to be clearly understood that resort may be had to various other embodiments, modifications, and equivalents thereof which, after reading the description herein, may suggest themselves to one of ordinary skill in the art without departing from the spirit of the present invention or the scope of the appended claims.

### EXAMPLE 1

### Preparation of an Alloy Composition by Arc Melting

In order to reduce the presence of contaminants in the alloys of the present invention, steps were taken to minimize the exposure of the alloy components to reactants such as air and moisture. In addition, high purity components were utilized in the present invention to minimize the introduction of existing contaminants from the individual alloy components that might interfere with the efficient operation of the alloy.

An arc melting crucible was loaded with about 120 g of nickel, 40 g of aluminum, 20 g of lithium, and 20 g of germanium. The crucible was then transferred to the vacuum chamber of the arc melting furnace with minimal exposure of the sample to the atmosphere. The vacuum chamber was placed under a dynamic vacuum for several minutes, and then refilled with argon. This pump and refill cycle was repeated one or two more times to achieve thorough removal of any remaining gaseous contaminants from the chamber. The upper, moveable electrode was placed into position, and the furnace was powered to achieve an arc to melt the sample. Typical power supplies used in this experiment provided approximately 2,000 amps. The moveable electrode was slowly and continuously moved around the sample to facilitate melting and up to a minute thereafter to facilitate mixing.

After this time, power to the furnace was shut off and the sample was allowed to cool for several minutes until it could be handled safely. After cooling was complete, the crucible was transferred to an inert atmosphere glove box or stored under vacuum to minimize exposure of the sample to the atmosphere until further processing.

The alloy sample produced in this fashion was cut into smaller samples of about 1 g to 5 g each. These smaller samples were placed into contact with distilled water to verify alloy activity. Gas bubbles were observed to form at the alloy surface when it was placed in water, and a sample of this gas was collected. A mass spectrometric analysis of the gas confirmed its identity as hydrogen. Hydrogen production was also inferred by adding an alloy sample to a fuel cell (VWR Scientific, Atlanta, Ga., Mini Fuel Cell # WLS30198), contacting the alloy distilled water, and using a voltmeter to confirm a potential of 1 V across the cell. Alloy samples of this size placed in water were monitored and observed to generate hydrogen over a period of 3 to 5 days.

### EXAMPLE 2

### Preparation of an Alloy Composition by Arc Melting using Pre-Melts

In some embodiments of this invention, it was desirable to form intermediate alloys comprising a subset of the alloy components, and thereafter use this intermediate alloy in a subsequent arc melting step along with the remaining alloy components. This example illustrates the use of such an intermediate alloy or “pre-melt” of nickel and aluminum. In an inert atmosphere dry box, an arc melting crucible was loaded with 120 g of nickel and 40 g of aluminum. This sample was handled and melted in the manner described in Example 1.

After cooling, the intermediate nickel-aluminum alloy, which appeared homogeneous, was combined with the remaining alloy components, 20 g of lithium and 20 g of germanium, and then melted in the arc melting furnace in the same manner described in Example 1. Further processing was carried out as outlined in Example 1. Small samples of this alloy (about 1 g to 5 g each) were placed in contact with water to examine the hydrogen-producing activity of the alloy, as described in Example 1. Hydrogen production was also inferred by adding an alloy sample to a fuel cell (VWR, Atlanta, Ga., Scientific Mini Fuel Cell # WLS30198), contacting the alloy distilled water, and using a voltmeter to confirm a potential of 1 V across the cell.

### EXAMPLE 3

### Preparation of an Alloy Composition by Arc Melting

The alloy components and the alloy made in this Example were handled in the manner described above in Example 1. A first pre-melt alloy was prepared from 12 g of nickel and 40 g of aluminum to prepare an intermediate alloy or “pre-melt” as described above in Examples 1 and 2. A second pre-melt alloy was prepared from 58.2 g of indium and 61.8 g of antimony in an arc melting furnace, as described above for the nickel-aluminum pre-melt alloy. Both these pre-melt alloys were further used in the final melt alloy.

The nickel-aluminum pre-melt alloy and the indium-antimony pre-melt alloy were combined with 20 g of lithium and 8 g of germanium in an arc melting crucible, and then melted in an arc melting furnace as described above in Example 1.

Small samples of this alloy (about 1 g to 5 g each) were placed in contact with water to verify the activity of the alloy. Hydrogen production was also inferred by adding an alloy sample to a fuel cell (VWR, Atlanta, Ga., Scientific Mini Fuel Cell # WLS30198), contacting the alloy distilled water, and using a voltmeter to confirm a potential of 1 V across the cell.

### EXAMPLE 4

### Preparation of an Alloy Composition by Induction Melting

To reduce the presence of contaminants in the alloys, samples were handled under argon and high purity components were utilized whenever possible. Melting of the alloy components in this Example was accomplished by induction melting, which involves the use of a high current, high frequency potential which is developed in a copper coil, the operation of which is well known to one of ordinary skill in the art. The sample was loaded into an insulated, graphite tube crucible with a quartz sheath, which was placed in the inner diameter of the copper coil. Melting was accomplished under a blanket of argon gas (1 atmosphere pressure). The induction melting furnace was powered until the sample was completely melted, usually for several minutes depending upon sample size. Power to the furnace was removed and the sample was allowed to cool until the sample could be handled safely. Like the arc melting furnace procedure of Example 1, this induction melting procedure allowed for pre-melts as well as final melts.

An induction melting crucible was loaded with 20 g of nickel, 40 g of aluminum, 20 g of lithium, 58.2 g of indium, and 61.8 g of antimony. These materials were then loaded into the induction furnace while minimizing their exposure to the atmosphere and placed under a slow, continuous flow of argon gas (1 atmosphere). The sample was melted as described above to form the alloy.

Small samples of this alloy were placed in contact with water to verify the hydrogen-producing activity of the alloy, as described in Example 1. Hydrogen production was also inferred by adding an alloy sample to a fuel cell (VWR, Atlanta, Ga., Scientific Mini Fuel Cell # WLS30198), contacting the alloy distilled water, and using a voltmeter to confirm a potential of 1 V across the cell.

### EXAMPLE 5

### Preparation of an Alloy Composition by Induction Melting using Pre-Melts

An induction furnace crucible was loaded with 13.4 g of nickel and 17.0 g of palladium and an intermediate alloy or “pre-melt” was prepared in an induction furnace as described above in Example 4. A second pre-melt alloy was prepared from 37.6 g of indium and 40.0 g of antimony in an induction furnace, under an inert atmosphere, as described. Both these pre-melt alloys were further used in the final melt alloy.

The nickel-palladium pre-melt alloy and the indium-antimony pre-melt alloy were combined with 6.0 g of aluminum, 3.0 g of lithium, 7.0 g of germanium, and 76.0 g of tin in the induction furnace crucible. This final melt alloy was melted in the induction furnace as described above in Example 4. A small portion (1 g to 5 g) of the final alloy sample was placed into contact with distilled water to verify its hydrogen-producing activity. Hydrogen production was also inferred by adding an alloy sample to a fuel cell (VWR, Atlanta, Ga., Scientific Mini Fuel Cell # WLS30198), contacting the alloy distilled water, and using a voltmeter to confirm a potential of 1 V across the cell.

### EXAMPLE 6

### Preparation of an Alloy Composition by Induction Melting

An induction furnace crucible was loaded with 13.4 g of nickel, 53.3 g of aluminum, 50.3 g of sodium, 7.0 g of germanium, and 76.0 g of tin. The alloy was prepared in an induction furnace as described above in Example 4. Small samples of this alloy (about 1 g to 5 g each) were placed in contact with water to verify its hydrogen-producing activity. Hydrogen production was also inferred by adding an alloy sample to a fuel cell (VWR, Atlanta, Ga., Scientific Mini Fuel Cell # WLS30198), contacting the alloy distilled water, and using a voltmeter to confirm a potential of 1 V across the cell.

### EXAMPLE 7

### Preparation of an Alloy Composition by Various Melting Methods

An arc melting crucible was loaded with a mixture comprising about 62.07% sodium, about 24.28% aluminum, about 5.00% nickel, and about 8.65% indium antimonide, by weight. The crucible was then transferred to the reaction chamber of the furnace, and the sample was processed as described in Example 1 to provide the alloy in block form. A small portion (1 g to 5 g) of the sample was placed into contact with distilled water to verify its hydrogen-producing activity. Hydrogen production was also inferred by adding an alloy sample to a fuel cell (VWR, Atlanta, Ga., Scientific Mini Fuel Cell # WLS30198), contacting the alloy distilled water, and using a voltmeter to confirm a potential of 1 V across the cell.

### EXAMPLE 8

### Preparation of an Alloy Composition by Various Melting Methods

An arc melting crucible was loaded with a mixture comprising about 41.38% sodium, about 48.56% aluminum, about 5.00% nickel, and about 5.06% indium antimonide, by weight. The crucible was then transferred to the reaction chamber of the furnace, and the sample was processed as described in Example 1 to provide the alloy in block form. A small portion (1 g to 5 g) of the sample was placed into contact with distilled water to verify its hydrogen-producing activity. Hydrogen production was also inferred by adding an alloy sample to a fuel cell (VWR, Atlanta, Ga., Scientific Mini Fuel Cell # WLS30198), contacting the alloy distilled water, and using a voltmeter to confirm a potential of 1 V across the cell.

### EXAMPLE 9

### Preparation of an Alloy Composition by Various Melting Methods

An arc melting crucible was loaded with a mixture comprising about 62.07% sodium, about 24.28% aluminum, about 2.5% nickel, about 2.5% palladium or platinum, and about 8.65% indium antimonide, by weight. The crucible was then transferred to the reaction chamber of the furnace, and the sample was processed as described in Example 1 to provide the alloy in block form. A small portion (1 g to 5 g) of the sample was placed into contact with distilled water to verify its hydrogen-producing activity. Hydrogen production was also inferred by adding an alloy sample to a fuel cell (VWR, Atlanta, Ga., Scientific Mini Fuel Cell # WLS30198), contacting the alloy distilled water, and using a voltmeter to confirm a potential of 1 V across the cell.

### EXAMPLE 10

### Preparation of an Alloy Composition by Various Melting Methods

An arc melting crucible was loaded with a mixture comprising about 41.38% sodium, about 48.56% aluminum, about 2.5% nickel, about 2.5% palladium or platinum, and about 5.06% indium antimonide by weight. The crucible was then transferred to the reaction chamber of the furnace, and the sample was processed as described in Example 1 to provide the alloy in block form. A small portion (1 g to 5 g) of the sample was placed into contact with distilled water to verify its hydrogen-producing activity. Hydrogen production was also inferred by adding an alloy sample to a fuel cell (VWR, Atlanta, Ga., Scientific Mini Fuel Cell # WLS30198), contacting the alloy distilled water, and using a voltmeter to confirm a potential of 1 V across the cell.

### EXAMPLE 11

### Processing an Alloy Composition in Powder Form

Any of the alloy compositions prepared in Examples 1 to 10 above can be processed from the block form, as it forms in these Examples, into powder. Processing the alloys into powder provides a sample with much greater surface area, thereby greatly increasing the amount of hydrogen gas that is produced upon exposure of the alloy to water.

Samples of the alloy composition prepared in Example 1 can be processed into powder form using standard techniques well known to one of ordinary skill in the art. Thus, samples of 100 mesh, 400 mesh, 3 micron, and 100 nanometer size powder can be formed. Each of these samples can be placed in contact with water and the generation of hydrogen gas can be monitored. The 100 mesh powder produces more hydrogen gas than the same amount of alloy in block form. The 400 mesh powder produces more hydrogen gas than the same amount of 100 mesh alloy. The 3 micron powder alloy produces even more hydrogen than the 100 or 400 mesh samples. The 100 nanometer powder produces the most hydrogen gas.

### EXAMPLE 12

### Alloy Composition in a Battery Electrode

Any of the alloys of the present invention is utilized in a battery that is designed and constructed according to standard battery designs known to one of ordinary skill in the art, to achieve high energy densities. The anode of the battery comprises the alloy composition of the present invention. The cathode of the battery comprises any common cathode material, typically carbon, the selection and design of which are well known. One example of cathode material is the carbon electrode found in zinc-air batteries. By way of example, an electrolyte such as an aqueous alkali metal salt is used, although the present invention anticipates the use of solution, paste, and other types of electrolytes known to one of ordinary skill in the art. If the alloy of the present invention used to make the anode comprises an alkali metal, then any suitable soluble salt may be used in the aqueous electrolyte, the selection of which is well known to one of ordinary skill in the art. If the alloy of the present invention used to make the anode does not comprise an alkali metal, then a salt containing hydroxide ion, typically potassium hydroxide, must be used in the aqueous electrolyte. An “activation strip” of insulator material is removably attached along one surface of the alloy anode to prevent contact between the alloy anode and the electrolyte of the battery before the battery is ready for use. This insulator material is then removed to allow contact between the anode and the electrolyte and thereby activate the battery.

In order to prevent the electrolyte from drying out as a result of the reaction of the electrolyte solution with the alloy, a means for oxidizing the hydrogen gas produced within this system is provided within the battery. Any of the well-known methods disclosed in the prior art may be utilized for this purpose. One such method is to use a platinum coated surface to allow the platinum to convert the hydrogen to water catalytically, in the presence of ambient oxygen. Another method employs a small amount of platinum into the alloy itself, obviating the need for any additional structures within the battery enclosure. Another method utilizes a material other than platinum, such as silver oxide, as described in the prior art.

### EXAMPLE 13

### Alloy Composition in a Capacitor Electrode

Any of the alloys of the present invention is useful in a capacitor/battery device of similar design as the hybrid capacitor/battery devices in the relevant art, to achieve high energy densities. In such devices, the anode of this capacitor/battery is made of a composite of the alloy of the present invention and high surface area carbon foams as used in super capacitor or ultra capacitor technologies known to one skilled in the art. The composite is constructed such that samples of alloy and carbon foam materials are brought into intimate contact along one edge of each material, such that a single monolith comprising two portions is formed. Alternatively, a carbon foam electrode that is impregnated with the alloy composition of the present invention may be employed. One carbon foam employed in such capacitor devices is manufactured by Mitsushita (Kyoto, Japan) and utilized in the Panasonic super capacitor EECA OEL 106 rated at 2.5 V at 10 farads. The cathode of the capacitor comprises any common cathode material, typically carbon, the selection and design of which are well known. One example of cathode material is the carbon electrodes found in zinc-air batteries. A dielectric material separating the anodic and cathodic half-cells is typically used, depending upon the particular capacitor design.

An electrolyte, such as an aqueous alkali metal salt is used, although the present invention anticipates the use of solution, paste, and other types of electrolytes known to one skilled in the art. If the alloy of the present invention used to make the anode comprises an alkali metal, then any suitable soluble salt may be used in the aqueous electrolyte, the selection of which is well known to one of ordinary skill in the art. If the alloy of the present invention used to make the anode does not comprise an alkali metal, then a salt containing hydroxide ion, typically potassium hydroxide, must be used in the aqueous electrolyte.

In order to prevent the electrolyte from drying out as a result of the reaction of the electrolyte solution with the alloy, a means for oxidizing the hydrogen gas produced within this system is provided within the battery. Any of the well-known methods disclosed in the prior art may be utilized for this purpose. One such method is to use a platinum coated surface or platinum mesh to allow the platinum to convert the hydrogen to water catalytically, in the presence of ambient oxygen. Another method employs a small amount of platinum into the alloy itself, obviating the need for any additional structures within the battery enclosure. Another method utilizes a material other than platinum, such as silver oxide, as described in the prior art.

The difference between the battery of Example 12 and the capacitor hybrid of this Example is that electrons from the alloy begin to accumulate along the surface of the carbon foam. Due to the high surface area of the carbon foam material and its operating characteristics, a high peak current is possible when discharging this device through a load. This hybrid capacitor device, like a capacitor, may be recharged from an external power source, however, this capacitor hybrid will also recharge itself over time as a result of the battery incorporated within its design.

### EXAMPLE 14

### Alloy Composition in a Fuel Cell Electrode and as a Fuel Source in a Hybrid Battery/Fuel Cell

The alloy of Example 1 of the present invention was utilized in a hybrid battery/fuel cell that is designed and constructed according to standard fuel cell designs known to one skilled in the art, to achieve high energy densities. The anode of the fuel cell was constructed in one of two ways. In one embodiment, the anode comprised the alloy composition of the present invention, in contact with a standard platinum black electrode. Moreover, these two anode components must be disposed where the hydrogen gas produced at the alloy portion of the anode contacted the platinum black portion of the anode and thereby served as a fuel for the fuel cell. In a second embodiment, the anode comprised the alloy of the present invention, wherein the alloy contained platinum as one of its components. Thus, the platinum served to convert the hydrogen to water in the operation of the fuel cell. The cathode of the fuel cell comprised any common fuel cell cathode material, the selection and design of which are well known. The cathode was contacted with oxygen that comprised the oxidant for the fuel cell system and was itself reduced to hydroxide during the operation of the fuel cell. An aqueous electrolyte comprising an alkali metal salt was used in this system. If the alloy of the present invention used to make the anode comprises an alkali metal, then any suitable soluble salt may be used in the aqueous electrolyte, the selection of which is well known to one of ordinary skill in the art. If the alloy of the present invention used to make the anode does not comprise an alkali metal, then a salt containing hydroxide ion, typically potassium hydroxide, is used in the aqueous electrolyte. An “activation strip” of insulator material was removably attached along one surface of the alloy anode to prevent contact between the alloy anode and the electrolyte of the fuel cell before it was ready for use. This insulator material was removed to allow contact and thereby activate the fuel cell.

Upon removal of the activation strip, the alloy anode of the present invention came into contact with the aqueous electrolyte, reaction initiated between the electrolyte and the alloy, and hydrogen was produced. The hydrogen was used in the direct production of energy in this fuel cell system, thus, hydrogen was oxidized at the anode and oxygen was reduced at the cathode.

This fuel cell system comprised an inherent method to prevent the electrolyte from drying out as a result of the reaction of the electrolyte solution with the alloy, namely, an internal means for oxidizing the hydrogen gas produced within the system.

### EXAMPLE 15

### Alloy Composition as a Hydrogen Source for a Fuel Cell

Any alloy of Examples 1-10 and 17-20 of the present invention was utilized in conjunction with a traditional fuel cell design by employing it solely as a source for hydrogen gas. Thus, upon contacting the alloy compositions of the present invention with water, or aqueous alkali metal hydroxide solutions, hydrogen gas was produced that was utilized by contacting it with the anode of a traditional hydrogen fuel cell system, designs of which are well known to those of skill in the art. In a typical experiment, an alloy of the present invention was added to a fuel cell (VWR, Atlanta, Ga., Scientific Mini Fuel Cell # WLS30198) which employed a platinum black anode (VWR # AA12755-03) and a carbon cathode (VWR # WLS30198). For alloys that contain group 1A alkali metals, it was only necessary to add water to activate the sample to produce hydrogen. In alloys of the present invention that do not contain alkali metals, it was necessary to add aqueous hydroxide ion, e.g. aqueous potassium hydroxide, to activate the sample to produce hydrogen. Upon contacting an alloy with either water or aqueous hydroxide ion, hydrogen was produced and a voltmeter to confirm a potential across the cell.

### EXAMPLE 16

### Alloy Composition as a Power Sourcefor an Emergency Radio

A battery or similar power source (1 Watt) is required to power a SARBE 5 Rescue Radio transmitter used in emergency or recovery situations. Using currently available technology such as a BE375 12.15 Volt battery, continuous operating time for this transmitter is only about 1 hour. In addition, the shelf life of conventional batteries such as the BE375 battery can limit their utility. A battery of the present invention addresses the limitations of conventional batteries by remaining inert when not in use, thereby greatly extending its shelf life, because the battery is not activated until the time of its use. Thus, the battery is stored until needed, at which time it can be activated by the addition of water.

In this embodiment, a battery/fuel cell design is used to power the SARBE 5 Rescue Radio. Using 1 g of potassium metal in an alloy composition of the present invention containing 60% alkali metal content by weight, the SARBE 5 Rescue Radio can be powered continuously (24 h/day) for a period of about 15 days, assuming a 50% efficiency in energy conversion.

### EXAMPLE 17

### Preparation of an Alloy Composition Without Alkali Metal

An arc melting crucible was loaded with a mixture comprising about 90% aluminum, about 5% nickel, and about 5% germanium, by weight. The crucible was then transferred to the reaction chamber of the furnace, and the sample was processed as described in Example 1 to provide the alloy in block form. A small portion (about 1 g) of the sample was removed and used in a fuel cell (VWR Scientific, Atlanta, Ga., Mini Fuel Cell # WLS30198). In this case, the alloy did not contain an alkali metal, therefore aqueous hydroxide ion, typically aqueous potassium hydroxide, was used to contact the alloy. A voltmeter was used to confirm a potential of 1 V across the cell, from which the production of hydrogen gas was inferred.

### EXAMPLE 18

### Preparation of Various Alloy Compositions Without Alkali Metal

The alloy compositions presented in the following table, all of which contain no alkali metal, are prepared using any of the processing techniques described earlier in the Detailed Description, including arc melting, induction melting, vapor deposition, and sintering, although arc melting is the preferred method. These materials are processed and tested as described in Example 17. A small portion (about 1 g) of the sample is removed and used in a fuel cell (VWR Scientific, Atlanta, Ga., Mini Fuel Cell # WLS30198). Since these alloys do not contain an alkali metal, aqueous hydroxide ion, typically aqueous potassium hydroxide, is used to contact the alloys to produce hydrogen gas. A voltmeter is used to confirm a potential of 1 V across the cell, from which the production of hydrogen gas is inferred.

Percent Composition by Weight of Alloys
of the Present Invention that Contain No Alkali Metal.

| Example | Transition | | Alkali | Semi- |
|---|---|---|---|---|
| No. | Metal | Aluminum | Metal | conductor |
| 18.1 | 70% Ni | 20% Al | — | 10% Ge |
| 18.2 | 16% Ni | 20% Al | — | 4% Ge |
| | | | | 29.1% In |
| | | | | 30.9% Sb |
| 18.3 | 20% Ni | 20% Al | — | 29.1% In |
| | | | | 30.9% Sb |
| 18.4 | 8.2% Ni | 3% Al | — | 20% Sb |
| | 8.5% Pd | | | 18.8% In |
| | | | | 3.5% Ge |
| | | | | 38% Sn |
| 18.5 | 5% Ni | 90% Al | — | 5% Ge |
| 18.6 | 1% Pd or Pt | 95% Al | — | 1.94% In |
| | | | | 2.06% Sb |

### EXAMPLE 19

### Preparation of an Alloy Composition Without Aluminum

An arc melting crucible was loaded with a mixture comprising about 90% lithium, about 5% nickel, and about 5% indium antimonide, by weight. Alternatively, indium (about 2.43%) and antimony (about 2.57%) metals were used in place of indium antimonide. The crucible was then transferred to the reaction chamber of the furnace, and the sample was processed as described in Example 1 to provide the alloy in block form. A small portion (about 1 g) of the sample was removed and used in a fuel cell (VWR Scientific, Atlanta, Ga., Mini Fuel Cell # WLS30198). The alloy was contacted with water, a voltmeter was used to confirm a potential of 1 V across the cell, from which the production of hydrogen gas was inferred.

### EXAMPLE 20

### Preparation of Various Alloy Compositions Without Aluminum

The following alloy compositions, also without aluminum as in Example 19, are prepared using any of the processing techniques described above, although arc melting is the preferred method. These materials are processed and tested as described in Example 19. A small portion (about 1 g) of the sample is removed and used in a fuel cell (VWR Scientific, Atlanta, Ga., Mini Fuel Cell # WLS30198). The alloy is contacted with water and a voltmeter is used to confirm a potential of 1 V across the cell, from which the production of hydrogen gas is inferred.

Percent Composition by Weight of Alloys
of the Present Invention that Contain No Aluminum.

| Example | Transition | | Alkali | Semi- |
|---|---|---|---|---|
| No. | Metal | Aluminum | Metal | conductor |
| 20.1 | 80% Ni | — | 10% Li | 10% Ge |
| 20.2 | 26% Ni | — | 10% Li | 4% Ge |
| | | | | 29.1% In |
| | | | | 30.9% Sb |
| 20.3 | 30% Ni | — | 10% Li | 29.1% In |
| | | | | 30.9% Sb |
| 20.4 | 9.7% Ni | — | 1.5% Li | 20% Sb |
| | 8.5% Pd | | | 18.8% In |
| | | | | 3.5% Ge |
| | | | | 38% Sn |
| 20.5 | 5% Ni | — | 90% Li | 5% Ge |
| 20.6 | 1% Pd or Pt | — | 60% Na or | 35% Sn |
| | | | K | 1.94% In |
| | | | | 2.06% Sb |

What is claimed is:

1. An alloy composition comprising:
at least one transition metal;
at least one high electron mobility component; and
aluminum or at least one group 1A alkali metal.

2. The alloy composition of claim 1, wherein the transition metal is iron, ruthenium, osmium, cobalt, rhodium, iridium, nickel, palladium, platinum, silver or gold.

3. The alloy composition of claim 1, wherein the transition metal is nickel, palladium, platinum, silver or gold.

4. The alloy composition of claim 1, wherein the transition metal is nickel.

5. The alloy composition of claim 1, wherein the group 1A alkali metal is lithium, sodium, or potassium.

6. The alloy composition of claim 1, wherein the high electron mobility component is characterized by an electron mobility value from about 100 cm²/V·s to about 100,000 cm²/V·s.

7. The alloy composition of claim 1, wherein the high electron mobility component is C, Si, Ge, Sn, AgBr, CdTe, HgSe, HgTe, AlAs, GaAs, GaSb, InP, InAs, InSb, SiC, ZnSiP₂, CdSiP₂, CdSnAs₂, CdIn₂Te₄, Hg₅In₂Te₈, PbSe, PbTe, Bi₂Te₃ or Te.

8. The composition of claim 1, wherein the high electron mobility component is Ge, Sn or InSb.

9. The composition of claim 1, wherein the high electron mobility component is Ge.

10. An alloy composition comprising:
at least one transition metal;
aluminum;
at least one group 1A alkali metal; and
at least one high electron mobility component

11. The alloy composition of claim 10, wherein the group 1A alkali metal and the aluminum are provided in a combined amount in a range of about 4% to about 95% of the composition by weight.

12. The alloy composition of claim 10, wherein the group 1A alkali metal and the aluminum are provided in a combined amount in a range of about 50% to about 95% of the composition by weight.

13. The alloy composition of claim 10, wherein the group 1A alkali metal and the aluminum are provided in a combined amount in a range of about 80% to about 95% of the composition by weight.

14. The alloy composition of claim 10, wherein the group 1A alkali metal and the aluminum are provided in a combined amount in a range of about 4% to about 50% of the composition by weight.

15. The alloy composition of claim 10, wherein the group 1A alkali metal and the aluminum are provided in a combined amount in a range of about 30% to about 50% of the composition by weight.

16. The alloy composition of claim 10, wherein the group 1A alkali metal and the aluminum are provided in a mole ratio in a range of about 10:1 to about 1:10 moles of alkali metal to moles of aluminum.

17. The alloy composition of claim 10, wherein the transition metal is iron, ruthenium, osmium, cobalt, rhodium, iridium, nickel, palladium, platinum, silver or gold.

18. The alloy composition of claim 10, wherein the transition metal is nickel, palladium, platinum, silver or gold.

19. The alloy composition of claim 10, wherein the transition metal is nickel.

20. The alloy composition of claim 10, wherein the group 1A alkali metal is lithium, sodium, or potassium.

21. The alloy composition of claim 10, wherein the high electron mobility component is characterized by an electron mobility value from about 100 cm²/V·s to about 100,000 cm²/V·s.

22. The alloy composition of claim 10, wherein the high electron mobility component is C, Si, Ge, Sn, AgBr, CdTe, HgSe, HgTe, AlAs, GaAs, GaSb, InP, InAs, InSb, SiC, ZnSiP₂, CdSiP₂, CdSnAs₂, CdIn₂Te₄, Hg₅In₂Te₈, PbSe, PbTe, Bi₂Te₃ or Te.

23. The composition of claim 10, wherein the high electron mobility component is Ge, Sn or InSb.

24. The composition of claim 10, wherein the high electron mobility component is Ge.

25. The alloy composition of claim 10, wherein the transition metal is nickel, the Group 1A alkali metal is lithium, sodium or potassium, and the high electron mobility component is germanium.

26. A method of producing hydrogen gas comprising the steps of:
providing the alloy composition of claim 1, wherein the aluminum is present; and
contacting the alloy composition with aqueous hydroxide ion.

27. A method of producing hydrogen gas comprising the steps of:
providing the alloy composition of claim 1, wherein the at least one group 1A alkali metal is present; and
contacting the alloy composition with water.

28. A method of producing hydrogen gas comprising the steps of:
providing the alloy composition of claim 10; and
contacting the alloy composition with water.

29. A method of manufacturing the alloy composition of claim 1, comprising the steps of:
providing the at least one transition metal, the at least one group 1A alkali metal, and the at least one high electron mobility component as ingredients;
melting the ingredients to form a mixture; and
cooling the mixture until the mixture solidifies.

30. A method of manufacturing the alloy composition of claim 1, comprising the steps of:
providing the at least one transition metal, the aluminum, and the at least one high electron mobility component as ingredients;
melting the ingredients to form a mixture; and
cooling the mixture until the mixture solidifies.

31. A method of manufacturing the alloy composition of claim 10, comprising the steps of:
providing the at least one transition metal, the aluminum, the at least one group 1A alkali metal, and the at least one high electron mobility component as ingredients;
melting the ingredients to form a mixture; and
cooling the mixture until the mixture solidifies.

32. A battery comprising an anode, a cathode, and an electrolyte, wherein the anode comprises the alloy composition of claim 1.

33. A battery comprising an anode, a cathode, and an electrolyte, wherein the anode comprises the alloy composition of claim 10.

34. A capacitor comprising an anode in contact with a sample of carbon foam, a cathode, an electrolyte, and a dielectric, wherein the anode comprises the alloy composition of claim 1.

35. A capacitor comprising an anode in contact with a sample of carbon foam, a cathode, an electrolyte, and a dielectric, wherein the anode comprises the alloy composition of claim 10.

36. A fuel cell comprising an anode, a cathode, and an electrolyte, wherein the anode comprises the alloy composition of claim 1.

37. A fuel cell comprising an anode, a cathode, and an electrolyte, wherein the anode comprises the alloy composition of claim 10.

38. A fuel cell assembly comprising a conventional hydrogen fuel cell and a hydrogen generator, wherein the hydrogen generator comprises the alloy composition of claim 1, wherein the at least one group 1A alkali metal is present, and water.

39. A fuel cell assembly comprising a conventional hydrogen fuel cell and a hydrogen generator, wherein the hydrogen generator comprises the alloy composition of claim 1, wherein the aluminum is present, and aqueous hydroxide ion.

40. A fuel cell assembly comprising a conventional hydrogen fuel cell and a hydrogen generator, wherein the hydrogen generator comprises the alloy composition of claim 10 and water.
